(19) United States
(12) Patent Application Publication
(10) Pub. No.: US 2017/0129222 A1
(43) Pub. Date: May 11, 2017

(54) OXYGEN-BARRIER MATERIAL IN PARTICULAR FOR SILAGE COVER

(71) Applicant: SOCIETE D'EXTRUSION DU POLYETHYLENE A. BARBIER ET CIE, Sainte Sigolene (FR)

(72) Inventors: Loïc BARALON, Sainte Sigolene (FR); Gérard PICHON, Monistrol Sur Loire (FR)

(73) Assignee: SOCIETE D'EXTRUSION DU POLYETHYLENE A. BARBIER ET CIE, Sainte Sigolene (FR)

(21) Appl. No.: 15/321,881

(22) PCT Filed: Jun. 19, 2015
(86) PCT No.: PCT/FR2015/051636

§ 371 Date: Dec. 23, 2016

(30) Foreign Application Priority Data
Jun. 25, 2014 (FR) 1455909

(51) Int. Cl. B32B 27/08; B32B 7/12; B32B 27/32

(52) U.S. Cl. CPC B32B 27/08; B32B 27/32; B32B 7/12; B32B 2307/7244; B32B 2410/00

(57) ABSTRACT

A multilayer material, notably for silage cover, that comprises an oxygen-barrier core layer sandwiched between at least two polyolefin layers, each polyolefin layer being separated from the barrier core layer by an adhesive layer, characterized in that at least one of the adhesive layers contains LCB-mLLDPE.

### FIELD OF THE INVENTION

The object of the invention is a multilayer plastic film that comprises at least one oxygen-barrier layer.

This invention is used for the cover and protection of agricultural products, such as those intended to be used in the production of silage. The multilayer film is notably used as covering for silage or wrapped fodder, its application including chopped hay or grain fodder, corn and such agri-food by-products as spent grains. The material in this invention can also be used as protection for the grain. In the latter application, the material is in the form of a sheath, not a film, formed so that grain is poured into a casing.

The most common technique of silaging chopped fodder is to pack it flat on a concrete surface between two walls, then compact it with tractors to expel as much interstitial air as possible. It is then fully covered for protection. The silage cover film is most often a multilayer film made of polyolefins. Sometimes its structure may integrate an airtight core layer. This airtight layer minimizes oxygen penetration into the silo to prevent aerobic fermentation phenomena that spoil the nutritional quality of the silage product. The core layer also promotes lactic fermentation, which occurs in anaerobic conditions and which is absolutely necessary to guarantee the nutritional quality of the silage product.

### DESCRIPTION OF THE PRIOR ART

Use of films for the storage, protection and preservation of agricultural silage is already known in the prior art. Multilayer films formed from assembling different materials have been disclosed in the prior art. Said films typically contain layers to provide mechanical strength such as polyethylene layers, and other layers that ensure airtightness such as polyamide layers.

EP2498990 proposes for example silage covers combining two detachable films so as to facilitate material recycling. The cover thus presents a multilayer inner film that forms a gas barrier and comprises at least one of the following materials: polyamide, polyester, ethylene-vinyl alcohol copolymer (EVOH), and an outer film that provides mechanical protection and comprises, inter alia, polyethylene, polypropylene and their copolymer derivatives.

JP 2003276123 proposes a film composed of three layers, used to form hay bales. The outer layers are polyolefin layers and the core layer is an aliphatic polyamide layer.

In a manner known in the prior art, polyamide and ethylene-vinyl alcohol copolymer (EVOH) are used as an oxygen-barrier layer in multilayer films. EVOH has an advantage over polyamide in that it has better sealing capabilities and is easier to recycle.

DE 102004008085 discloses a multilayer barrier film of approximately 170 82 m. The film is mechanically stable and comprises an oxygen-barrier core layer formed of ethylene-vinyl alcohol copolymer (EVOH), preferably sandwiched between two layers of polyethylene and thus protected from mechanical stress.

EP 1035762 proposes a mono- or multilayer film as a silo cover containing at least one air-barrier layer, preferably comprising polyamide (PA) or other materials such as ethylene-vinyl alcohol copolymer (EVOH) and polyvinyl alcohol (PVOH), and mixtures thereof. This document also discloses a multilayer film composed of PE/PA/PE or PE/EVOH/PE, the PE layers containing binders and dyes. In principle, the farmer places an outer film on top of said film, which confers mechanical characteristics to the whole.

WO 2013061264 discloses a multilayer film for silage cover, whose oxygen-barrier layer is made of polyamide or EVOH. The cover also has polyolefin layers comprising, inter alia, mLLDPE on both sides of the barrier layer. These polyolefin layers are attached to the barrier core layer through an adhesive layer made of linear PE. Nevertheless, the impact strength values (dart test) proposed are only 95 g.

The films disclosed in these documents are typically manufactured using a blown extrusion method which obtains films that are no wider than 8 m. The composition of the film itself imposes this limit, as it does not allow the bubble to obtain sufficient stability during manufacture. Furthermore, the presence of an oxygen-barrier layer such as EVOH weakens the film's mechanical strength at long lengths. It follows that several webs have to be welded together to obtain wider films, up to 20 m consistent with silage use, i.e. consistent with EN 13207 requirements for thermoplastic silage films.

The film thus obtained has the drawback of a discontinuous oxygen barrier, in particular at the welded sites. Consequently, the film has areas where the oxygen barrier is broken.

In other words, the problem that the invention proposes to resolve is that of developing a film with a continuous oxygen-barrier layer for silage that is greater than 5 m wide, advantageously at least 6 m wide, preferably greater than 8 m wide, while retaining mechanical characteristics that meet the aforementioned EN 13207 requirements. These conditions notably include impact strength measured by the so-called dart test method. The dart test value is determined using a methodology described in two identical standards, ISO 7765-1 and ASTM D1709. According to EN 13207, this dart test value must be greater than 300 g.

US2011/0003099A1 discloses the use of LCB-mLLDPE to manufacture films coextruded with other polyolefin layers. The multilayer films considered contain no oxygen-barrier layer. It appears that the choice of polymer decreases the low haze effect on the surface of the film.

US6313241B1 discloses the use of LCB-mLLDPE/vinyl copolymers. The films obtained are used in packaging as they are suitable for high speed extrusion. It is also specified that the films obtained are clear, with few surface imperfections.

WO94/07930 discloses LCB-mLLDPE polymers for manufacturing films due to its elastic properties during extrusion.

### DISCLOSURE OF THE INVENTION

To solve this problem, the assignee noted that the presence of LCB-mLLDPE polyethylene in at least one layer of the multilayer film would, in its development by blown coextrusion, confer sufficient mechanical strength and stability to the bubble so as to obtain films greater than 8 m wide with a dart test value >300 g. Consequently, these films have an oxygen-barrier layer that is continuous at all points and is consistent with EN 13207.

Accordingly, the object of this invention is a multilayer material, in particular for silage cover, comprising a central oxygen-barrier core layer sandwiched between at least two polyolefin layers, each polyolefin layer being separated from the barrier core layer by an adhesive layer. The material is characterized in that at least one of the adhesive layers contains LCB-mLLDPE.

According to the invention, the invention material may be in either film or sheath form. The multilayer film is more specifically used as covering for silage or wrapped fodder. The sheath is more specifically used to protect the grain during its storage after harvesting.

In the following disclosure, the invention is more specifically disclosed in conjunction with the use of the material in film form.

LCB-mLLDPE (from the English acronym for Long Chain Branched-metallocene Linear Low Density PolyEthylene) means linear low density polyethylene containing long-chain branches, themselves formed of ethylene or mLLDPE monomers. More precisely, this polyethylene copolymer is obtained by homogeneous catalysis known as metallocene catalysis. LCB-mLLDPE is thus obtained by incorporating into the primary mLLDPE backbone, polyethylene or mLLDPE macromonomers with a terminal vinyl group, these macromonomers constituting the branches (LCB).

This polyethylene copolymer (mLLDPE) may comprise branched or linear CH₂═CH—CₙH₂ₙ₊₁ (wherein n is between 2 and 6) α-olefin comonomers such as 1-hexene in particular, or alternatively methyl pentene with formula CH₂═CH—CH₂CH (CH₃)—CH₃.

In other words, LCB-mLLDPE (from the English acronym for Long Chain Branched-metallocene Linear Low Density PolyEthylene) designates a homopolymer or copolymer comprising a primary chain (LLPDE) consisting of branched or linear CH₂═CH—CₙH₂ₙ₊₁ (wherein n is between 0 and 6) α-olefin comonomers and at least one pendant chain (LCB) with at least 10, preferably at least 50, more preferably at least 100, advantageously at least 150, ideally at least 200 or even 250 carbon atoms, the pendant chain comprising a homopolymer or copolymer consisting of branched or linear CH₂═CH—CₙH₂ₙ₊₁ (wherein n is between 0 and 6) α-olefin comonomers. According to another feature, the pendant chains are distributed along the primary chain with an average frequency from 0.1 to 5 pendant chains per 1,000 carbon atoms from the primary chain. LCB-mLLDPE are notably disclosed in WO94/07930, mentioned above and hereby incorporated by way of reference.

According to a preferred embodiment, LCB-mLLDPE is an mLLDPE/1-hexene copolymer with long-chain branches (LCB). It could notably include the Enable®(for example Enable 20-05HH) copolymer sold by ExxonMobil Chemical, or the Lumicene® Supertough copolymer sold by Total Petrochemicals, which have densities between 0.910 et 0.935.

According to an advantageous embodiment, at least one of the adhesive layers comprises at least 20% preferably at least 40% LCB-mLLDPE by weight, advantageously between 50 and 80%, and more advantageously between 60 and 80%. That helps stabilize the film during bubble formation.

The polyolefin and core layers are by nature chemically different. Consequently, adhesive layers must be inserted between them to ensure good bonding. This prevents potential interlayer delamination problems.

Advantageously, the adhesive layers therefore independently comprise polyolefin resins other than LCB-mLLDPE wherein at least one binder is chosen from the group comprising: low density polyethylene (LDPE); linear low density polyethylene obtained by heterogeneous catalysis (Ziegler-Natta) (LLDPE), or obtained by homogeneous catalysis (metallocene) (mLLDPE); maleic anhydride-grafted LLDPE; medium density polyethylene (MDPE); high density polyethylene (HDPE); ethylene-vinyl acetate copolymer (EVA); ethylene-butyl acrylate (EBA); ethylene-methyl acrylate copolymer (EMA); ethylene-ethyl acrylate copolymer (EEA); polypropylene (PP); propylene-ethylene copolymer; ethylene-acrylic acid copolymer (EAA), ethylene-methacrylic acid copolymer (EMAA); ethylene-maleic anhydride copolymer; and ethylene-acrylic ester-maleic anhydride copolymer (EAEMA). In an advantageous embodiment, the adhesive layer(s) comprise(s) maleic anhydride-grafted LLDPE.

According to an advantageous embodiment of the invention, at least one of the adhesive layers of the multilayer film comprises LCB-mLLDPE/1-hexene and maleic anhydride-grafted LLDPE. In practice, the binder represents at least 20%, advantageously between 40 and 50%, preferably between 30 and 40% by weight adhesive layer.

In practice, each of the adhesive layers represents between 5 and 30% of the total thickness, advantageously around 20%.

The core layer of the film according to the invention is the air-barrier layer. This core layer advantageously comprises at least one material chosen from the group comprising:

ethylene-vinyl alcohol copolymer (EVOH), (co)polyamide, (co)polyamide/polyolefin alloy, (co)polyester, and vinyl alcohol polymer (PVOH). The core layer preferably comprises EVOH copolymer with 4 to 15% thickness, advantageously of the order of 9% of the total thickness of the film.

The physiochemical properties of the EVOH copolymer vary according to the respective concentrations of the various constituent comonomers. Thus, the greater the molar percentage of ethylene monomer, the greater the core layer's mechanical strength.

According to a particular embodiment, the EVOH copolymer comprised in the core barrier layer has a molar percentage of ethylene monomer preferably between 10 and 60, more preferably between 38 and 48. Advantageously, the EVOH copolymer comprises a molar percentage of ethylene monomer equal to 44.

As previously specified, impermeability to gas and particularly to oxygen in the air, an essential property in films for silage covers, is notably ensured by the barrier core layer. Another requirement is to ensure good mechanical strength and durability. This requirement is notably ensured by adhesive layers and polyolefin layers.

Advantageously, the polyolefin layers independently comprise at least one material chosen from the group comprising: low density polyethylene (LDPE); linear low density polyethylene, obtained by heterogeneous catalysis (Ziegler-Natta) (LLDPE) or obtained by homogeneous catalysis (metallocene) (mLLDPE); medium density polyethylene (MDPE); high density polyethylene (HDPE); ethylene-vinyl acetate copolymer (EVA); ethylene-butyl acrylate (EBA); ethylene-methyl acrylate copolymer (EMA); ethylene-ethyl acrylate copolymer (EEA); polypropylene (PP); propylene-ethylene copolymer; ethylene-acrylic acid copolymer (EAA), ethylene-methacrylic acid copolymer (EMAA); ethylene maleic anhydride copolymer; and ethylene-acrylic ester-maleic anhydride copolymer (EAEMA).

Preferably, the polyolefin layers contain primarily mLLDPE. This advantageously includes mLLDPE/1-hexene copolymer, and notably includes the Exceed° 1018CA copolymer sold by ExxonMobil Chemical or the Eltex® PF6212KJ copolymer sold by Ineos, which have densities between 0.910 and 0.922.

The thickness of a polyolefin layer advantageously represents between 20 and 45% of the total thickness.

According to an advantageous embodiment, the multilayer film for silage cover that is the object of this invention contains between 5 and 9 layers. Advantageously, the film comprises an oxygen-barrier core layer, two adhesive layers, and at least two polyolefin layers.

According to another advantageous embodiment, the multilayer film for silage cover that is the object of this invention contains five layers: two identical polyolefin layers, one air-barrier core layer, and at least one adhesive layer containing LCB-mLLDPE.

The film preferably comprises five layers, including two identical polyolefin layers, one oxygen-barrier core layer, and two potentially identical adhesive layers.

Advantageously, the multilayer film contains five layers according to the embodiments described above, and has a thickness preferably between 25 and 250 μm, more preferably between 100 and 135 μm.

As previously stated, the multilayer films of the invention have an impact strength value (dart test) that is consistent with international standard EN1320, i.e. greater than 300 g. As will be seen below, the presence of LCB-mLLDPE instead of LDPE allows wide bubbles to be produced and high mechanical strength to be obtained, in spite of the presence of a middle layer composed of an oxygen-barrier polymer.

A person skilled in the art will know to select the appropriate additive(s) that may be incorporated into the different layers of the film of this invention. In a non-limiting way, said additives may be organic additives, notably: anti-UV agents, slip agents, fluorinated polymers, mineral fillers, and mineral and/or organic pigments and dyes.

Advantageously according to this invention, the multilayer films are wider than 5 m, advantageously wider than 8 m, preferably wider than 10 m, and more preferably wider than 14 m.

According to one advantageous embodiment, the multilayer film of this invention with a thickness between 100 and 135 μm has:
excellent consistency in the thickness of the EVOH layer throughout its entire width, which guarantees permeability to oxygen on all surface points in accordance with DIN 53380-3, at 23° C. and 50% relative humidity, less than 2.5 cm³/(m².day.bar), i.e. at least 100 times more oxygen-tight than a standard silage film of the same thickness formulated using polyolefins.
functional mechanical properties for the application as silo cover for silage are, inter alia: Dart test F50>300 g (in accordance with EN 13207 and measured using EN ISO 7765-1).

Furthermore, the multilayer film according to the invention is mechanically recyclable. Tests performed on an industrial scale showed that material thus recycled could be used as is or mixed with polyethylene without generating extrudability problems or loss of mechanical properties by the extruded film.

It has therefore been demonstrated that said film presents no recycling problems if it is recovered after use and mixed with used agricultural films made of polyolefins only. This film shows no risk of altering the quality of the recycled plastic materials from the collection of used agricultural films.

The invention also relates to a thermoplastic film for silage consisting of the previously described multilayer material. Said film has a width of at least 5 meters, advantageously at least 8 meters.

The invention and advantages thereof will become more apparent from the following non-limiting examples given to describe the invention.

### EMBODIMENTS OF THE INVENTION

### EXAMPLE 1

Using a blown extrusion method, a film is obtained with an average thickness of 115 μm and a width of 12 m, with 5 successive layers, the composition of which is detailed in

Table 1:
A first outer layer A composed of PE predominately of mLLDPE.
A first adhesive layer B composed predominately of LCB-mLLDPE and maleic anhydride-grafted LLDPE as the binder.
An oxygen-barrier core layer C composed predominately of EVOH.
A second adhesive layer D composed predominately of LDPE and maleic anhydride-grafted LLDPE as the binder.
A second external layer E composed predominately of mLLDPE and PE.

TABLE 1

| | Thickness | | |
|---|---|---|---|
| Layer | (μm) | % by weight | Type of material |
| E | 28.75 | 69% | mLLDPE |
| (Outer | | 23% | PE |
| bubble) | | 5% | MM UVⁱ |
| | | 3% | MM ANTIBLOCⁱⁱ |
| D | 23.575 | 66.20% | LDPE |
| | | 25% | Maleic anhydride-grafted LLDPE |
| | | 8.80% | MM GREEN UVⁱⁱⁱ |
| C | 10.35 | 99% | EVOH |
| | | 1% | MMPPA^{iv} |
| B | 23.575 | 66.20% | LCB-mLLDPE |
| | | 25% | Maleic anhydride-grafted LLDPE |
| | | 8.80% | MM BLACK^{v} |
| A | 28.75 | 69.50% | mLLDPE |
| (Inner | | 23% | PE |
| bubble) | | 7.50% | MM BLACK |

MM = Master Mix
ⁱMM UV (10% AntiUV such as HALS)
ⁱⁱMM ANTIBLOC (70% aluminum silicate)
ⁱⁱⁱMM GREEN (pigment + 7% Anti UV such as HALS)
^{iv}MMPPA (2% Fluoroeleastomer)
^{v}MM BLACK (40% Carbon Black)

The film shows the physiochemical characteristics detailed in Table 2:

TABLE 2

| | | |
|---|---|---|
| Tensile strength | ISO 527-3 | 27.5 MPa |
| longitudinal | | |
| direction | | |
| Tensile strength | ISO 527-3 | 27.5 MPa |
| transverse direction | | |
| Elongation at break | ISO 527-3 | 540% |
| (longitudinal | | |
| direction) | | |
| Elongation at break | ISO 527-3 | 520% |
| (transverse | | |
| direction) | | |
| Dart test | ISO 7765-1 | 321 g |

The following table lists the microscopic measurements of thickness at 13 points separated by about 1 m over the entire width, on microtome cut.

| | | | | | | | | | | | | | |
|---|---|---|---|---|---|---|---|---|---|---|---|---|---|
| EVOH | 10.2 | 10.5 | 10.2 | 10.7 | 10.7 | 10.3 | 11 | 10.5 | 10.2 | 10.6 | 11.2 | 11.8 | 10.2 |

As seen in the table, the thickness of the barrier layer is constant over the entire width, confirming that it is continuous with no break area at the oxygen barrier.

### EXAMPLE 2

### EXAMPLE 2.1

### No LCB-mLLDPE in Layer B

Using the blown extrusion method, a film is obtained with an average thickness of 120 μm and width of 12 m, with 5 successive layers, the composition of which is detailed in Table 3:
A first outer layer A composed of PE and predominately of mLLDPE and other PE.
A first adhesive layer B composed predominately of LDPE and maleic anhydride-grafted LLDPE acting as binder.
An oxygen-barrier core layer C composed predominately of EVOH.
A second adhesive layer D composed predominately of LDPE and maleic anhydride-grafted LLDPE as the binder.
A second outer layer E composed predominately of mLLDPE and another PE.

TABLE 3

| | %/film | | |
|---|---|---|---|
| | thickness | | |
| Layer | ratio | % by weight | Type of material |
| E | 25 | 69% | mLLDPE |
| (Outer | | 23% | PE |
| bubble) | | 5% | MM UVⁱ |
| | | 3% | MM ANTIBLOCⁱⁱ |
| D | 20.5 | 66.20% | LDPE |
| | | 25% | Maleic anhydride-grafted LLDPE |
| | | 8.80% | MM GREEN UVⁱⁱⁱ |
| C | 9 | 99% | EVOH |
| | | 1% | MMPPA^{iv} |
| B | 20.5 | 66.20% | LDPE |
| | | 25% | Maleic anhydride-grafted LLDPE |
| | | 8.80% | MM BLACK^{v} |
| A | 25 | 69.50% | mLLDPE |
| (Inner | | 23% | PE |
| bubble) | | 7.50% | MM BLACK |

MM = Master Mix
ⁱMM UV (10% AntiUV such as HALS)
ⁱⁱMM ANTIBLOC (70% aluminum silicate)
ⁱⁱⁱMM GREEN (pigment + 7% Anti UV such as HALS)
^{iv}MMPPA (2% Fluoroeleastomer)
^{v}MM BLACK (40% Carbon Black)

### EXAMPLE 2.2

### LCB-mLLDPE Present in Layer B

In this example, the composition of the multilayer film is identical to the film in Example 2.1, with the exception that the 66.20% LDPE in layer B is replaced by 66.20% LCB-mLLDPE.

The film has the physiochemical characteristics detailed in Table 4:

TABLE 4

| | Test method | Example 2.1 | Example 2.2 | unit |
|---|---|---|---|---|
| Dart test | ISO 7765-1 | 251 | 341 | g |

The following table lists the microscopic measurements of thickness at 13 points separated by about 1 m over the entire width of the film in Example 2.2, on microtome cut.

| | | | | | | | | | | | | | |
|---|---|---|---|---|---|---|---|---|---|---|---|---|---|
| EVOH | 7.2 | 7.5 | 7.2 | 7.7 | 7.7 | 7.3 | 8 | 7.5 | 7.2 | 7.6 | 8.2 | 8.8 | 7.2 |

As seen in the table, the thickness of the barrier layer is constant over the entire width, confirming that it is continuous with no break area at the oxygen barrier.

### EXAMPLE 3

### EXAMPLE 3.1

### No LCB-mLLDPE in Layer B

Using the blown extrusion method, a film is obtained with an average thickness of 120 μm and width of 12 m, with 5 successive layers, the composition of which is detailed in

Table 5:

TABLE 5

| | %/film | | |
|---|---|---|---|
| | thickness | | |
| Layer | ratio | % by weight | Type of material |
| E | 25 | 69% | mLLDPE |
| (Outer | | 23% | PE |
| bubble) | | 5% | MM UVⁱ |
| | | 3% | MM ANTIBLOCⁱⁱ |
| D | 20.5 | 66.20% | LDPE |
| | | 25% | Maleic anhydride-grafted LLDPE |
| | | 8.80% | MM GREEN UVⁱⁱⁱ |
| C | 9 | 99% | EVOH |
| | | 1% | MMPPA^{iv} |
| B | 20.5 | 70% | LLDPE |
| | | 25% | Maleic anhydride-grafted LLDPE |
| | | 5% | MMUV |
| A | 25 | 69.50% | mLLDPE |
| (Inner | | 23% | PE |
| bubble) | | 7.50% | MM BLACK |

### EXAMPLE 3.2

### LCB-mLLDPE Present in Layer B

In this example, the composition of the multilayer film is identical to the film in Example 3.1, with the exception that the 70% LLDPE in layer B is replaced by 70% LCB-mLLDPE.

The film has the physiochemical characteristics detailed in Table 4:

TABLE 6

| | Test method | Example 2.1 | Example 2.2 | unit |
|---|---|---|---|---|
| Dart test | ISO 7765-1 | 245 | 478 | g |

The following table lists the microscopic measurements of thickness at 12 points separated by about 1 m over the entire width of the film in Example 3.2, on microtome cut.

| | | | | | | | | | | | | |
|---|---|---|---|---|---|---|---|---|---|---|---|---|
| EVOH | 7.2 | 8.5 | 8.3 | 7.7 | 9.7 | 11 | 10 | 12 | 10 | 9.4 | 9.4 | 9.1 |

As seen in the table, the thickness of the barrier layer is constant over the entire width, confirming that it is continuous with no break area at the oxygen barrier.

1. A multilayer material comprising a central oxygen-barrier core layer sandwiched between at least two polyolefin layers, each polyolefin layer being separated from the barrier core layer by an adhesive layer, wherein at least one of the adhesive layers contains LCB-mLLDPE.

2. The multilayer material according to claim 1, wherein said LCB-mLLDPE is an mLLDPE/1-hexene copolymer with long-chain branches (LCB).

3. The multilayer material according to claim 1, wherein at least one of the adhesive layers comprises at least 20% by weight LCB-mLLDPE.

4. The multilayer material according to claim 1, wherein the adhesive layers independently also comprise at least one material chosen from the group comprising: LDPE; MDPE; HDPE; maleic anhydride-grafted LLDPE; LLDPE; mLLDPE; ethylene-vinyl acetate copolymer (EVA); ethylene-butyl acrylate (EBA); ethylene-methyl acrylate copolymer (EMA); ethylene-ethyl acrylate copolymer (EEA); polypropylene (PP); propylene-ethylene copolymer; ethylene-acrylic acid copolymer (EAA); ethylene-methacrylic acid (EMAA); ethylene-maleic anhydride copolymer; and ethylene-acrylic ester-maleic anhydride copolymer (EAEMA).

5. The multilayer material according to claim 1, wherein at least one of the adhesive layers comprises LCB-mLLDPE and maleic anhydride-grafted LLDPE.

6. The multilayer material according to claim 1, wherein the core layer comprises at least one material chosen from the group consisting of: ethylene-vinyl alcohol copolymer (EVOH); (co)polyamide;
(co)polyamide/polyolefin alloy; (co)polyester; and PVOH.

7. The multilayer material according to claim 1, wherein the polyolefin layers independently comprise at least one material chosen from the group consisting of: LDPE; mLLDPE; LDPE;
LLDPE; MDPE; HDPE; ethylene-vinyl acetate copolymer (EVA); ethylene-butyl acrylate (EBA); ethylene-methyl acrylate copolymer (EMA); ethylene-ethyl acrylate copolymer (EEA); polypropylene (PP); propylene-ethylene copolymer; ethylene-acrylic acid (EAA); ethylene-methacrylic acid (EMAA); ethylene-maleic anhydride copolymer; and ethylene-acrylic ester-maleic anhydride copolymer (EEAMA).

8. The multilayer material according to claim 1, wherein the polyolefin layers comprise mLLDPE.

9. The multilayer material according to claim 1, wherein said multilayer material contains 5 layers, including two identical polyolefin layers and at least one adhesive layer containing LCB-mLLDPE.

10. The multilayer material according to claim 1, wherein said multilayer material contains 5 layers, including two identical polyolefin layers and two identical adhesive layers.

11. The multilayer material according to claim 1, wherein said multilayer material contains 5 layers and has a thickness of between 25 and 250 μm.

12. The multilayer material according to claim 1, wherein said multilayer material is in the form of a film at least 5 m wide.

13. The multilayer material according to claim 1, wherein said multilayer material his in sheath form.

14. A thermoplastic silage film comprising the multilayer material according to claim 1.

15. The multilayer material according to claim 3, wherein at least one of the adhesive layers comprises between 60 and 80% by weight LCB-mLLDPE.

16. The multilayer material according to claim 6, wherein the core layer comprises the EVOH copolymer.

17. The multilayer material according to claim 11, wherein said multilayer material has a thickness of between 100 and 135 μm.

18. The multilayer material according to claim 12, wherein said multilayer material is in the form of a film at least 8 meters wide.

19. A thermoplastic silage film comprising the multilayer material according to claim 2, wherein at least one of the adhesive layers comprises at least 20% by weight LCB-mLLDPE.

20. The thermoplastic silage film according to claim 19, wherein the adhesive layers independently also comprise at least one material chosen from the group comprising: LDPE; MDPE; HDPE; maleic anhydride-grafted LLDPE; LLDPE; mLLDPE; ethylene-vinyl acetate copolymer (EVA); ethylene-butyl acrylate (EBA); ethylene-methyl acrylate copolymer (EMA); ethylene-ethyl acrylate copolymer (EEA); polypropylene (PP); propylene-ethylene copolymer; ethylene-acrylic acid copolymer (EAA); ethylene-methacrylic acid (EMAA); ethylene-maleic anhydride copolymer; and ethylene-acrylic ester-maleic anhydride copolymer (EAEMA).
